(19) United States
(12) Patent Application Publication
(10) Pub. No.: US 2012/0140093 A1
(43) Pub. Date: Jun. 7, 2012

(54) IMAGE CAPTURE DEVICE AND METHOD

(75) Inventor: PING-YANG CHUANG, Tu-Cheng (TW)

(73) Assignee: HON HAI PRECISION INDUSTRY CO., LTD., Tu-Cheng (TW)

(21) Appl. No.: 12/982,896

(22) Filed: Dec. 31, 2010

(30) Foreign Application Priority Data
Dec. 3, 2010 (TW) 99142251

(51) Int. Cl. H04N 9/68

(52) U.S. Cl. 348/234; 348/E09.053

(57) ABSTRACT

An image capture device includes a light sensor, a projector and a processing unit. The light source detects luminance value of ambient light. The projector projects images by using light generated by a light source included in the projector. The processing unit obtains luminance value from the light sensor in response to a capture operation; determines whether the obtained luminance value is less than a predetermined value; and controls the projector to adjust the luminance of the light source and capturing image simultaneously if the luminance value is less than the predetermined value.

### BACKGROUND

1. Technical Field

The present disclosure relates to an image capture device and a method thereof.

2. Description of Related Art

A projector can be mounted to an image capture device. Images captured by the image capture device can be directly projected by the projector. Image capture devices may also include a flash module for low light settings. Having the flash module and the projector, both of which can provide light, together is expensive and unnecessary.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric diagram of an electronic device; the electronic device includes a projector and an image capture device in accordance with a first exemplary embodiment.

FIG. 2 is a block diagram of the electronic device of FIG. 1.

FIG. 3 is a flowchart of a method for capturing images with the image capture device of FIG. 1.

FIG. 4 is a flowchart of a method for adjusting luminance of light provided by the projector of FIG. 1.

FIG. 5 is a block diagram of an image capture device in accordance with a second exemplary embodiment.

### DETAILED DESCRIPTION

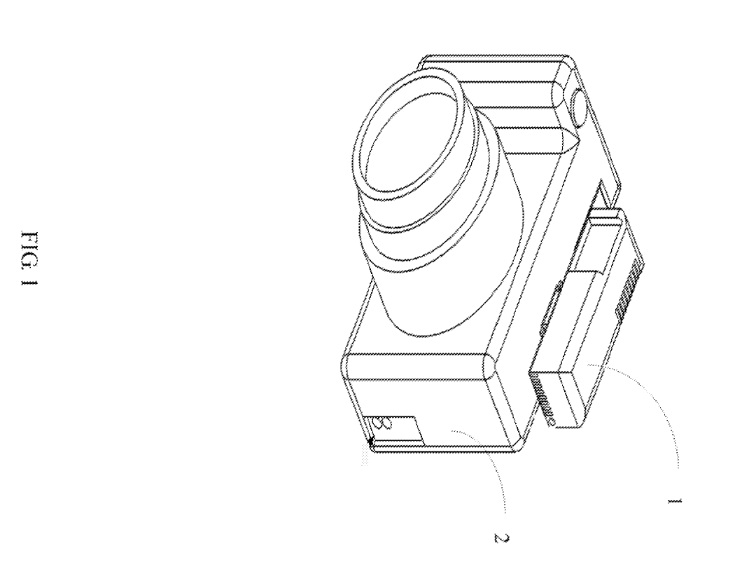

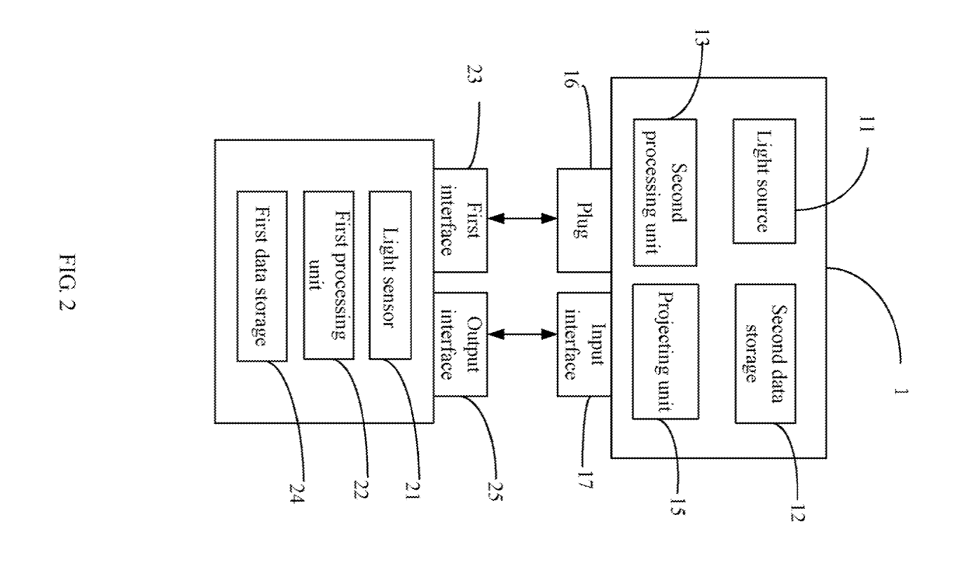

Referring to FIGS. 1-2, in a first exemplary embodiment, an electronic device 10 that includes a projector 1 and an image capture device 2 is provided. The image capture device 2 includes a light sensor 21, a first processing unit 22, a first interface 23, and a first data storage 24. The image capture device 2 and the projector 1 are connected through the first interface 23. The first data storage 24 stores images captured by the image capture device 2. The light sensor 21 detects luminance value of ambient light. The first processing unit 22 obtains the luminance value from the light sensor 21 in response to a capture operation and determines whether the obtained luminance value is less than a predetermined value. If the luminance value is not less than the predetermined value, the first processing unit 22 captures the image without light provided by the projector 1. If the luminance value is less than the predetermined value, the first processing unit 22 turns on the projector 1 to provide light for the image capture device 2, and simultaneously captures an image.

The projector 1 includes a light source 11, a second data storage 12, a second processing unit 13, a projecting unit 15, and a plug 16. The projector 1 is mounted to the image capture device 2 by plugging of the plug 16 into the first interface 23. When the projector 1 is turned on, the light source 11 provides light for the projector 1 and the projecting unit 15 projects images using the light provided by the light source 11.

The second processing unit 13 obtains the size of an aperture and a shutter speed of the image capturing device 2 when the projector 1 is turned on in response to the capture operation, and adjusts the luminance of the light generated by the light source 11 accordingly.

In order to obtain a pure white light, in this embodiment, the image projected by the projecting unit 15 is a blank image.

The image capture device 2 further includes an output interface 25. The projector 1 further includes an input interface 17. The input interface 17 of the projector 1 can be connected to the output interface 25 of the image capture device 2. The second processing unit 13 obtains images from the image capture device 2 and projects the obtained image.

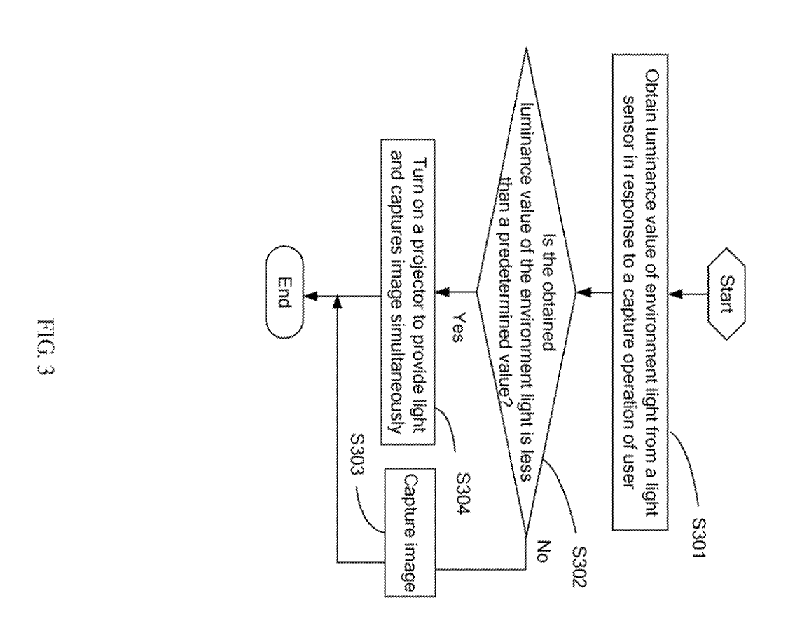

FIG. 3 is a flowchart of a method for capturing images by the image capture device 2 of FIG. 1. In step S301, the first processing unit 22 obtains the luminance value of the ambient light from the light sensor 21 in response to the capture operation.

In step S302, the first processing unit 22 determines whether the obtained luminance value is less than the predetermined value.

If the obtained luminance value is not less than the predetermined value, in step S303, the first processing unit 22 captures image without additional light being provided by the projector 1, and then the procedure is finished.

If the obtained luminance value is less than the predetermined value, in step S303, the first processing unit 22 turns on the projector 1 to provide additional light and captures an image simultaneously.

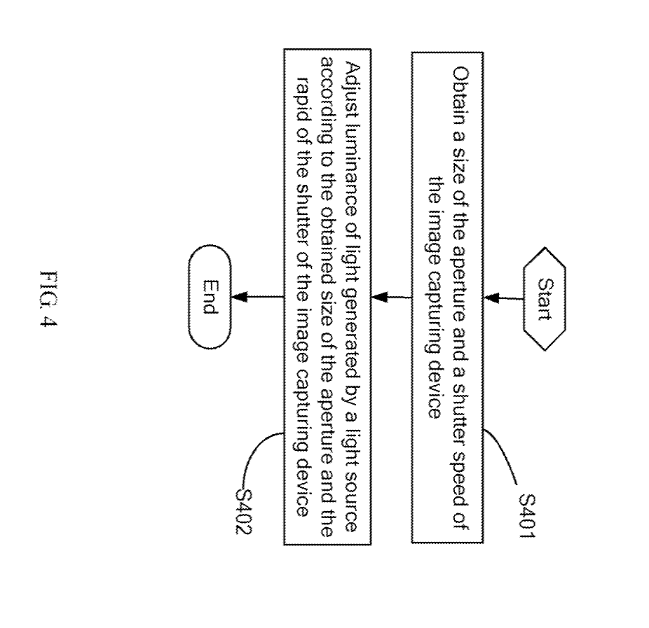

FIG. 4 is a flowchart of a method for adjusting light emitted by the projector 1 of FIG. 1. In step S401, the second processing unit 13 obtains the size of the aperture and the shutter speed of the image capturing device 2 if the projector 1 is turned on in response to the capture operation.

In step S402, the second processing unit 13 adjusts the luminance of the light generated by the light source 11 according to the obtained aperture size and shutter speed of the image capturing device 2.

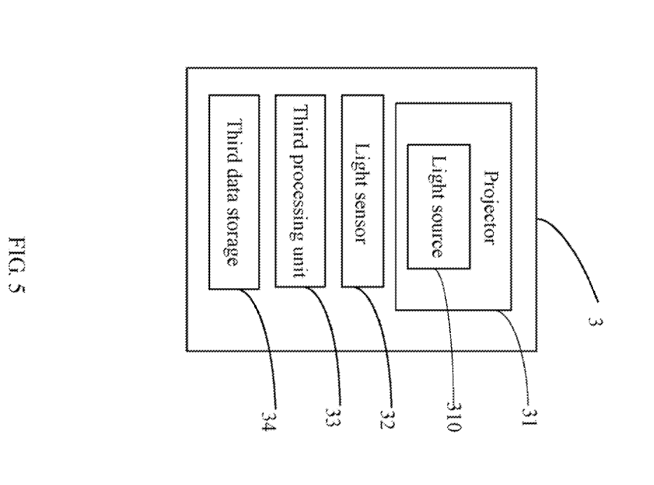

In a second exemplary embodiment, as shown in FIG. 5, the projector 1 of the first embodiment can be a component of the image capture device 3, namely, the image capture device 3 further includes a projector 31. The projector 31 includes a light source 310. The function of the light source 310 is the same as the light source 21 of the first embodiment. The function of a light sensor 32 of the image capture device 3 is the same as the light sensor 21 of the first embodiment. The functions implemented by the second processing unit 13 and the first processing unit 22 of the first embodiment are implemented by a third processing unit 33 of the image capture device 3. The data stored in the first data storage 24 and the second data storage 13 of the first embodiment are stored in a third data storage 34 of the image capture device 3.

Although, the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. An electronic device comprising:
a projector; and
an image capture device;
the image capture device comprising:
a light sensor for detecting luminance value of ambient light; and
a first processing unit for obtaining the luminance value from the light sensor in response to a capture operation, determining whether the obtained luminance value is less than a predetermined value; and turning on the projector to provide additional lighting and capturing an image simultaneously;
wherein projector comprises:
a light source for providing light for the projector;
a project unit for projecting images by using the light provided by the light source; and
a second processing unit for obtaining a size of an aperture and a shutter speed of the image capturing device when the projector is turned on in response to the capture operation, and adjusting the luminance of the light generated by the light source according to the obtained size of the aperture and shutter speed of the image capturing device.

2. The electronic device as described in claim 1, wherein the projector projects a blank image in response to the capture operation.

3. The electronic device as claimed in claim 1, wherein the image capture device further comprises an output interface, the projector further includes an input interface, the input interface of the projector is connected to the output interface of the image capture device, the second processing unit obtains images from the image capture device and projects the obtained images.

4. An image capture device, comprising:
a light sensor for detecting luminance value of ambient light;
a projector for projecting images by using light generated by a light source comprised in the projector; and
a processing unit for obtaining luminance value of the ambient light from the light sensor in response to a capture operation; determining whether the obtained luminance value is less than a predetermined value; controlling the projector to adjust the luminance of the light source and capturing image simultaneously if the luminance value is less than the predetermined value.

5. The image capture device as claimed in claim 4, wherein the way for adjusting the luminance of the light source by the processing unit is: obtaining a size of an aperture and a shutter speed of the image capturing device and adjusting the luminance of the light generated by the light source according to the obtained size of the aperture and the shutter speed of the image capturing device.

6. The image capture device as claimed in claim 4, the projecting unit projecting a blank image in response to the capture operation.

7. An image capture method, comprising:
obtaining luminance value of ambient light from a light sensor in response to a capture operation;
determining whether the obtained luminance value is less than a predetermined value; and
adjusting luminance of light source in a projector and capturing image simultaneously if the luminance value is less than the predetermined value.

8. The method as claimed in claim 7, wherein the way for adjusting the luminance of the light source is:
obtaining a size of an aperture and a shutter speed of the image capturing device; and
adjusting the luminance of the light generated by the light source according to the obtained size of the aperture and shutter speed of the image capturing device.

9. The method as claimed in claim 7, wherein the projector projects a blank image in response to the capture operation.
